(19) United States
(12) Patent Application Publication
(10) Pub. No.: US 2005/0232286 A1
(43) Pub. Date: Oct. 20, 2005

(54) System and method for route optimization using piggybacking in a mobile network

(75) Inventors: Sung-Jin Lee, Suwon-si (KR); Hyun-Jeong Kang, Seoul (KR); Jong-Keun Na, Seongnam-si (KR); Seong-Ho Cho, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/110,047

(22) Filed: Apr. 20, 2005

(30) Foreign Application Priority Data
Apr. 20, 2004 (KR) 2004-27086

(51) Int. Cl. H04L 12/28

(52) U.S. Cl. 370/401

(57) ABSTRACT

A route optimization system and method for packet transmission between particular nodes in a mobile network including a plurality of nodes. If a predetermined mobile router (MR) receives a packet transmitted from a predetermined mobile node (MN) connected to its subnet, the MR transmits the packet to its associated home agent (HA) through a previously established default tunnel. Upon receiving the packet, the HA adds registration information of the MR to the packet and transmits the registration information-added packet to a correspondent router (CR) of a correspondent node (CN) for which the packet is destined. The CR acquires registration information of the MR from the received packet, and forms a route-optimized tunnel for packet transmission to the MR according to the acquired information.

### PRIORITY

This application claims priority under 35 U.S.C. §119 to an application entitled “System and Method for Route Optimization Using Piggybacking in a Mobile Network” filed in the Korean Intellectual Property Office on Apr. 20, 2004 and assigned Serial No. 2004-27086, the contents of which are incorporated herein by reference.

### BACKGROUND OF THE INVENTION

1. Field of the Invention

The present invention relates generally to Mobile Internet Protocol version 6 (IPv6), which is a next generation IP, and in particular, to a system and method for optimizing a complicated transport route when mobile routers coexist in one network, overlapping each other.

2. Description of the Related Art

Currently, along with the spread of IP networks, a wired section of a cellular network is also evolving into an IP-based Internet network. Even computers, which were developed only for use in a wired environment, are required to provide services while seamlessly maintaining continuity in a high-speed wireless environment.

As described above, in the existing Internet environment, only the wired environment is taken into consideration. That is, IP addresses are allocated to terminals only one time and connections of the terminals are maintained through the allocated IP addresses. Consequently, movement of the terminals is never taken into consideration. In some cases, however, a terminal using an IP address to which data should be transmitted may move to another place, the IP network is used even in a wired section of a mobile network environment, and the terminals support a voice call function and also a data communication function.

Therefore, in order for a terminal allocated the conventional fixed IP address to normally transmit data while on the move, the followings procedure is required. That is, even after a corresponding IP address is allocated to the terminal, a home network is required to continuously pursue a position of the terminal, which travels from place to place, and store positional information of the terminal whose position is being pursued. Herein, the term “home network” refers to a network from which the terminal is first allocated an IP address and in which the terminal is registered. A detailed description of the home network will be made later.

In order to meet the foregoing requirements, Mobile IP has been developed, which basically supports mobility of an IP terminal and provides a function of pursuing a position of the IP terminal and storing the positional information.

A Transport Control Protocol/Internet Protocol (TCP/IP), a standard protocol for providing Internet communication for computers, has a hierarchical structure like other network protocols. This structure is called a protocol stack, a protocol suite, or a protocol structure. Herein, the term “protocol stack” will be used, for convenience.

The TCP/IP protocol stack, is based on two protocols, i.e., a TCP and an IP. The IP protocol is a protocol corresponding to Open Systems Interconnection (OSI) Layer 3 L3, and currently, Internet Protocol version 4 (IPv4) is commonly used for the IP protocol. The IP protocol selects a route targeting a connection between physical subnetworks and a destination IP address.

That is, the IP protocol allocates source (or origination) addresses and destination addresses to a plurality of terminals or nodes, which are devices implementing the IP protocol, all of which are connected to the Internet, and analyzes the source and destination addresses.

In the current internetwork layer, communication between hosts on networks is performed using 32-bit IP addresses. The IP address distinguishes a specific node using a network IP and a node IP (or host IP).

Since the 1990's, there has been a need for improvement of the foregoing IPv4 protocol, because of a lack of allocable resources due to a dramatic increase in use of the Internet and because of a lack of mobility and security. Accordingly, IPv6 has been developed as a new standard protocol for solving these shortcomings.

The IPv6 protocol, also known as Internet Protocol next generation (IPng), has extended a length of an IP address from 32 bits to 128 bits. In this manner, the IPv6 protocol can solve the Internet address resource exhaustion problem of the IPv4 protocol, and processes multimedia data in real time. Although the IPv4 protocol should separately install a patch protocol called ‘Internet Protocol Security (IPsec) Protocol’ for a security function, the IPv6 protocol includes the IPsec function therein, thereby strengthening the security function.

However, the IPv6 protocol is different from the IPv4 protocol in header structure. Therefore, there is no compatibility between the two protocols. Accordingly, it is expected that the IPv4 networks will be increasingly replaced with IPv6 networks or hetero-networks supporting both the IPv4 and the IPv6.

Table 1 below illustrates a structure of a standard protocol for the IPv6.

TABLE 1

| | Layer |
|---|---|
| Application layer | Application |
| Transport layer | TCP/UDP |
| Internetwork layer | IPv6 (ICMPv6) |
| Physical layer | Physical |

Referring to Table 1, an IPv6-based TCP/IP standard protocol includes an application layer, a transport layer implemented with Transport Control Protocol/User Datagram Protocol (TCP/UDP), an internetwork layer implemented with IPv6 or Internet Control Message Protocol for IPv6 (ICMPv6), and a physical layer.

The IPv6 protocol, like the existing IPv4 protocol, is comprised of two parts, i.e., a header and a payload. The payload is used for delivering transmission data between two hosts. The IPv6 header has a fixed 40-byte size and does not have a header check sum field, which has been proven to cause a serious bottleneck in the IPv4.

The IPv6 protocol, as described above, has a header structure for mobility support, security support, and quality guarantee for multimedia applications, all of which are not supported by the IPv4 protocol. For example, the header of the IPv6 protocol includes, as basic header fields, a Version field (4 bits), a Traffic Class field (8 bits), a Flow Label field (20 bits) related to quality-of-service (QoS), an Unsigned Integer Payload field (16 bits) representing a length of contents, a Next Header (NH) field (8 bits) defining a type of a header following the IPv6 header, an Unsigned Integer Hop field (8 bits), which decreases by 1 at each node that forwards a packet, a Source Address field (128 bits) representing an address of a packet transmitter, and a Destination Address field (128 bits) representing an address of a packet receiver.

Extended header fields included to perfectly implement the IPv6 include a Hop-by-Hop Option field, a Destination Option header, a Routing header, a Fragment header, an Authentication header, and an Encapsulating Security Payload (ESP) header.

The foregoing IPv6 protocol is mainly implemented by software, such that it should be suitable for an environment where personal computers are used, and is commonly processed by an operating system such as Windows, Linux, and Real-Time OS.

FIG. 1 is a diagram illustrating conventional Mobile IPv6-based network architecture. Referring to FIG. 1, the Mobile IPv6 includes mobile nodes (MNs) 110 and 170, a home agent (HA) 120, and a router 150. In addition, a network environment forming the Mobile IPv6 includes a home network 100, an Internet network 130, and a foreign network 140.

The MNs 110 and 170 are movable terminals that are allocated mobile IPs and perform packet data communication with the allocated mobile IPs. The home network 100 represents a network in which the MNs 110 and 170 are first registered. The HA 120 is a router of the home network 100, which relays the home network 100 in which the MNs 110 and 170 are registered to another network, e.g., the foreign network 140. More specifically, the HA 120 manages registration information of the MNs 110 and 170.

Because the MN1 110 that is first registered in the home network 100 has mobility, if it moves from the home network 100 to another network, the network to which the MN1 110 has moved becomes a foreign network 140 for the MN1 110. That is, in FIG. 1, because the MN1 110 has moved from the home network 100 to a position of the MN2 170, the network to which the MN2 170 has now moved becomes the foreign network 140. If another MN3 (not shown) was first registered in the foreign network 140 and allocated a home IP therefrom and then has moved to a position of the home network 100, the foreign network 140 serves as a home network and the home network 100 serves as a foreign network for the MN3.

If the MN1 110 moves to a position of the MN2 170, i.e., if the MN1 110 currently located in the home network 100 visits the foreign network 140, the MN2 170 cannot use the IP address first allocated in the home network 100, in the foreign network 140. Therefore, the foreign network 140 allocates, to the MN2 170, a Care of Address (CoA), which is a new temporary IP address that can be used in the foreign network 140.

In the Mobile IPv6 environment, which is now under discussion, as described above, an IP is allocated a total of 128 bits. Among the 128 bits, most significant bits (MSBs) are designated as a prefix value used for network identification, and least significant bits (LSBs) are designated as a Layer 3 address value distinguishable for each terminal.

Therefore, if the MN2 170 moves from the home network 100 to the foreign network 140, the router 150 of the foreign network 140 checks Layer 3 information in the IP address of the MN2 170, and based on the information, determines that the MN2 170 is a mobile terminal that has moved from another network to its network. In this case, the router 150 checks a prefix value in the IP of the terminal, and based on the prefix value, generates a new Layer 3 address according to a predetermined rule.

Thereafter, the router 150 determines if a duplicate address is generated in the new address generation process. That is, the MN2 170, when it visits a new network, is allocated a CoA, which is a temporary IP address that is different from the IP address allocated in the home network 100, and transmits/receives data through the allocated CoA as long as it is located in the foreign network 140.

Although the MN2 170 has moved to the new network, i.e., the foreign network 140, all data transmitted to the MN2 170 is transmitted to the network in which the MN2 170 was first registered, i.e., the home network 100. Therefore, in order for the MN2 170 to receive the data transmitted thereto, the MN2 170 should provide the HA 120 with its positional information.

Therefore, if the MN2 170 visits the foreign network 140 and is allocated a new CoA therefrom, the router 150 of the foreign network 140 binds a temporary IP address of the MN2 170, i.e., CoA information of the MN2 170, and an IP address originally used by the MN2 170 in the home network 100 together, and transmits the binding result to the HA 120 via the Internet network 130 using a Binding Update message 180.

Upon receiving the Binding Update message 180, the HA 120 checks the received Binding Update message 180, matches the IP address used by the MN2 170 in the home network 100 to the CoA allocated in the foreign network 140, and stores the matching result in a predetermined table. Thereafter, the HA 120 intercepts all packets destined for a home IP address of the MN2 170, i.e., a network address of the home network 100, and transmits the intercepted packets to the foreign network 140.

More specifically, the HA 120 checks a CoA of the MN2 170, depending on the stored table, determining that the received packet is destined for the MN2 170. Thereafter, the HA 120 attaches a header to the packet through encapsulation, sets a destination address for the packet to a CoA address of the MN2 170, and transmits the resultant packet to the MN2 170 (as shown by arrow 185).

Accordingly, all packets destined for the MN2 170, received at the HA 120, are transmitted to the foreign network 140, defining that the home network 120 and the foreign network 140 are tunneled for the MN2 170.

The foregoing environment requires additional functions as a mobile network environment becomes complicated. That is, in the past, only one terminal is taken into consideration. However, as communication technology increasingly evolves into a complicate wireless Internet environment, one network includes small networks therein and each of the small networks also includes smaller networks therein.

For example, a terminal moves through a small-sized network like a personal area network, or in some cases, a small or large-sized network itself moves, such as a wireless Internet apparatus, like an intelligent transportation system in which a small network is formed within a vehicle to provide Internet access service to the passengers.

In this case, the conventional Mobile IP technology has a limitation in providing service, and packet transmission suffers a drop (or disconnection). In order to solve this problem, Internet Engineering Task Force (IETF), an Internet standard group, has newly made the Network Mobility (NEMO) Working Group to independently deal with the technologies that were standardized by the Mobile IP Working Group. A protocol for NEMO Support is called a NEMO Basic Support protocol. The NEMO Basic Support protocol supports transparent network mobility to all mobile network nodes located in a mobile network, based on bidirectional tunneling between each mobile router (MR) and an HA.

FIG. 2 is a diagram illustrating a conventional network architecture using a conventional NEMO Basic Support protocol. Referring to FIG. 2, respective MRs, for example, MR1s 210 and 240, or MR2s 225 and 245, control mobility management of their networks, and when the MRs themselves move from their home networks 200 and 215 where they were first located, to a foreign network 230, they register their positional information and mobile network prefixes used in their mobile networks in their associated HAs 205 and 220, for example, an MR1_HA 205 and an MR2_HA 220. Further, when registering their locations in this manner, the respective MRs perform a prefix scope binding update, which is a concept extended in Mobile IPv6.

In the following description, an HA in which a particular MR is first registered will be represented by “MR_HA” for convenience. Therefore, an HA for the MR1 210 becomes the MR1_HA 205, and an HA for MR2 225 becomes MR2_HA 220. In addition, if a particular MR visits the foreign network 230, which is a new network, and is allocated a CoA therefrom, the allocated CoA value will be represented by “MR_CoA.”

As described above, the MR1_HA 205 and the MR2_HA 220 store information on the MR1 210 and the MR2 225, respectively, and each time the MRs 210 and 225 move, store their information in a table for the foregoing binding update.

As illustrated in FIG. 2, after the mobile network prefixes are registered, a bidirectional tunnel 260 between the MR1 240 that has moved to the foreign network 230 and the MR1_HA 205 is established. Once the bidirectional tunnel 260 between the MR1 240 and the MR1_HA 205 is established, the MNs (MN1 and MN2) belonging to the MR1 240 can exchange packet data with a correspondent node (CN) 280, which is a particular Internet node through the bidirectional tunnel 260, receiving transparent mobility support.

Similarly, after the mobile network prefixes are registered, a bidirectional tunnel 270 between the MR2 245 that has moved to the foreign network 230 and the MR2_HA 220 is established, and the MNs (MN3 and MN4) belonging to the MR2 245 can exchange packet data with the CN 280 through the bidirectional tunnel 270, receiving transparent mobility support.

With reference to FIG. 2, a description will now be made of a process of transmitting a packet from the CN 280 to the MN2 belonging to the MR1 240 on the assumption that the MR1 210 moves from the home network 200 in which it is first registered, to the foreign network 230 (as shown by arrow 250) and then the MR1 240 that has moved to the foreign network 230 is allocated a new CoA that can be used in the foreign network 230.

The CN 280, as it stores a home IP of the MR1 210, which is a mobile router of the MR2, sets a destination address of a transmission packet to the home IP of the MN2 before transmission. The transmitted packet, as it uses the home IP of the MN2 as its destination address, is delivered to the home network 200 of the MR1 210 through routing in the Internet network.

The HA 205 of the MR1, i.e., MR1_HA 205, receiving the packet through Internet routing, intercepts a packet whose mobile network prefix is identical to a mobile network prefix for the MN2, and acquires a CoA for a point to which the mobile network is currently connected, from information registered in a table in which mapping information of an HoA and a CoA is stored through binding cache, i.e., a binding update. Thereafter, the intercepted packet tunnels through the registered CoA of the MR1, i.e., MR1_CoA, and the bidirectional tunnel 260 previously established between the MR1 240 and the MR1_HA 205.

The tunneling is commonly used to enable a packet to detour around an intermediate destination to its original destination in an IP network. That is, the tunneling refers to an operation in which a packet whose destination address is destined for a mobile network undergoes tunneling by an HA, i.e., an additional IP header with which the packet can make a detour around an MR is attached to the packet and then routed to the MR, and the MR receiving the packet performs detunneling, i.e., removes the additional IP header to acquire its original packet and then re-routes the IP header-removed packet to the destination. Because the IP tunneling is a well-known known art, a detailed description thereof will be omitted herein.

The tunneled packet is encapsulated such that its source address becomes an MR1_HA and its destination address becomes a CoA of the MR1, i.e., an MR1_CoA. The encapsulated packet is routed along the tunneled route, i.e., the tunnel 260, and transmitted to the MR1 240 through the Internet network and a router 235 of the foreign network 230. Thereafter, the MR1 240 receiving the packet decapsulates the received packet and then delivers the decapsulated packet to the MN2, which is the final destination in the MR1 240 itself.

The MR1 240 performs tunneling and encapsulation to deliver a packet provided from an ingress interface, through the tunnel 260 established between the MR1 240 and the MR1_HA 205. A source address of the encapsulated packet becomes the CoA of the MR1 240, i.e., MR1_CoA, and a destination address thereof because an address of the MR1_HA 205, registered in a binding update list. The binding update list is used to manage a binding update operation performed by the MR1 240. The binding update list is a list in which an MR stores addresses of an HA and a CN that the MR should bind. The binding update list is a structure defined in Mobile IPv 6, and a detailed description thereof will be omitted herein herein.

If a packet 265 arrives at the MR1_HA 205, the MR1_HA 205 decapsulates the packet and routes the decapsulated packet to the CN 280, which is a final destination of the packet.

In the foregoing conventional NEMO support technology, each of the MRs establishes a tunnel to its own HA, for example, MR_HA. Thereafter, if the MR receives a packet destined from an MN connected to its subnet, the MR first delivers the packet up to a corresponding HA, through the established tunnel, and then the HA transmits the packet to its original destination, i.e., the CN, desired by the MN.

If a mobile network is located within its original home network, a packet is delivered by the conventional IPv6 routing scheme. The HA maintains a binding cache as described above, thereby determining if the mobile network exists in its original home network. If a binding update with a lifetime value set to 0 (lifetime=0) is received from an MR, an entry of a registered binding cache is no longer effective. That is, upon the MR discovering that it has returned to its home network, the MR transmits a binding update with lifetime=0 to the HA, thereby informing the HA that it has returned to its original home network.

Although it is assumed in the foregoing description that the MR1 210 moves to the foreign network 230, the MR2 225 can also undergo the same operation. That is, the MR2 225 can move from its home network 215 to the foreign network 230, which is a new network. In this case, mobile nodes MN3 and MN4 belonging to the MR2 225 also move together with the MR2 225.

The MR2 245 that has moved to the foreign network 230 is allocated a new CoA from the foreign network 230, and then transmits the corresponding information to the MR2_HA 220, an HA of the MR2, using a Binding Update message. Accordingly, a tunnel 270 is formed between the MR2 245 and the MR2_HA 220. A packet 275 delivered from the CN 280 to an MN3 or MN4 belonging to the MR2 245 is intercepted by the MR2_HA 220 and then transmitted to the MR2 245 through the tunnel 270.

Thereafter, the MR2 245 receiving the packet, if the received packet is destined for an MN, e.g., MN3 or MN4, managed by the MR2 245 itself, transmits the packet to the corresponding MN.

FIG. 3 is a diagram illustrating overlapping network architecture using the conventional NEMO Basic Support protocol. In FIG. 3, another MR belongs to an MR1 330 connected to an AR 325, i.e., an MR2 335. For example, this situation corresponds to a network configuration including the personal area network and the intelligent transportation system described above.

That is, assuming that the MR2 335 is a mobile router included in the personal area network and the MR1 330 is a mobile router attached to a particular vehicle, as the vehicle moves, the MR1 330 may leave its home network and may be located in another network, i.e., a foreign network. In another case, the MR2 335 may belong to coverage of the MR1 330 as it leaves its home network and boards the vehicle.

For example, it can be considered herein that an MN1 and an MN2 moving together with the MR1 330 are various communication devices attached to the vehicle and an MN3 and an MN4 moving together with the MR2 335 are various communication devices carried by individuals.

In this case, if a particular mobile terminal MN3 or MN4, carried by an individual, desires to communicate with a particular CN 380, the MR2 335 and the MR1 330 should form tunnels an MR2_HA 305 and an MR1_HA 300, respectively.

As described above, the NEMO Basic Support technology has a basic mechanism in which each of MRs forms a tunnel between the MR itself and its HA, and transmits a packet destined from its subnet to the outside, via the HA, through the formed tunnel.

Therefore, the MR1 330 creates a tunnel 350 to the MR1_HA 300 and the MR2 335 creates a tunnel 360 to the MR2_HA 305. However, because the MR2 335 is located in a subnet of the MR1 330, the MR1 330 should process a packet transmitted from the MR2 335, such that the packet should be transmitted via the MR1_HA 300 of the MR1 330 itself. That is, the tunnel 360 formed from the MR2 335 up to the MR2_HA 305 should necessarily be formed passing through the tunnel 350 between the MR1 330 and the MR1_HA 300.

As a result, it can be noted in FIG. 3 that a route of the tunnel 360 between the MR2 335 and the MR2_HA 305 is formed through the tunnel 350 between the MR1 330 and the MR1_HA 300, which is an unnecessary route.

As can be understood from the foregoing description, an increase in number of the overlapping MRs increases the number of unnecessarily established routes.

FIG. 4 is a diagram illustrating routes inefficiently established through unnecessary nodes in a network using the conventional NEMO Basic Support protocol. In FIG. 4, three MRs overlap each other triply, by way of example. In this case, as another MR is added to a subnet, as compared with FIG. 2 where two MRs overlap each other, a route should also pass through one more tunnel, increasing its complexity.

A description will now be made of a packet transmission process between a particular mobile node MN 440 or MN 445 and a CN 420 according to the NEMO Basic Support protocol, when an MR2 430 is connected to a subnet of an MR1 425 in an overlapping manner and the MN 440 or the MN 445 is connected to a subnet of the MR2 430 as illustrated in FIG. 4.

Referring to FIG. 4, before an MR 3 435 and its mobile node MN 440 or MN 445 are connected, there is a bidirectional tunnel formed between the MR1 425 and its MR1_HA 400 and there is a bidirectional tunnel formed between the MR2 430 and its MR2_HA 405. That is, because the MR2 430 is connected to a subnet of the MR1 425, the tunnel connected between the MR2 430 and the MR2_HA 405 should necessarily pass through the tunnel formed between the MR1 425 and the MR1_HA 400, forming a double tunnel. In this state, if the MR3 435 is connected to the subnet of the MR2 430, a new tunnel is connected between the MR 3 435 and its MR 3_HA 410, thereby forming a triple tunnel.

Therefore, when the MN 440 or the MN 445 accesses a link of the MR2 430 via the MR 3 435 to transmit a packet to the CN 420, the corresponding packet undergoes the following 3 tunnelings:
1. Tunneling from MR3 to MR3_HA;
2. Tunneling from MR2 to MR2_HA; and
3. Tunneling from MR1 to MR1_HA.

When the 3 tunnelings are formed, a packet transmitted (or destined) from the MN 440 or MN 445 to the CN 420 is transmitted to the CN 420 through the MR3 435 via the MR2 430, the MR1 425, the MR1_HA 400, the MR2_HA 405, the MR3_HA 410, and an MN_HA 415. In the following description, an HA in which a position to which a particular MN has moved is registered will be referred to as “MN_HA,” for convenience. That is, in Mobile IP, every MN has an HA in which its mobile position should be registered, and the MN_HA refers to the HA.

As described above, an increase in the number of MRs increases the complexity of the tunneling, resulting in an increase in complexity of a transmission route of a packet and in the size of a header added to the packet.

That is, in the overlapping network of FIG. 4, when a packet is transmitted from an MN to a CN, the packet passes through many unnecessary routes. For example, in the foregoing triple-tunnel network, a packet destined from a particular MN to a particular CN is transmitted to its original destination, i.e., the CN, through all of unnecessary routes on the Internet, i.e., MR1→MR1_HA→MR2_HA→MR3_HA→MN_HA.

FIG. 5 is a concept diagram illustrating a structure of tunnels formed between an MN to a CN in the overlapping tunnel (or nested tunnel) architecture illustrated in FIG. 4. Referring to FIG. 5, a triple tunnel is formed from an MN 510 to a CN 580. That is, a packet passes through 3 tunnels 525, 545, and 565 when transmitted from the MN 510 to the CN 580. Each time the packet passes one tunnel, a header is additionally added thereto.

More specifically, for communication between the MN 510 and the CN 580, the tunnel 525 between an MR3 520 and an MR3_HA 530, the tunnel 545 between an MR2 540 and an MR2_HA 550, and the tunnel 565 between an MR1 560 and an MR_HA1 570 are formed.

In a tunnel section 565 between the MR1_HA 570 and the MR1 560, as all of the 3 tunnels overlap each other, three unnecessary headers are attached to a packet when it is transmitted through the tunnel section 565. The added headers are not related to the data to be transmitted by the packet, and become unnecessarily wasted information, i.e., overhead.

As described above, when overlapping tunnels are formed in a network environment where multiple mobile routers overlap each other, transmission packets are transmitted to their original destinations, after passing through unnecessary routes on the Internet, causing a long transmission delay, which is dependent on the number of overlapping routers.

In order to solve this problem, many route optimization technologies have been proposed for reducing the unnecessarily increased number of routes. However, the route optimization technologies cannot still solve the duplicate overhead problem and additionally have a security problem.

Another problem in the NEMO Basic Support protocol is that when mobile networks overlap each other, a drawback caused by the overlapping tunnels occurs. Such a problem is known as a ‘dog-leg’ or ‘pinball’ routing problem, and this routing problem creates a complicated, inefficient routing path, thereby causing a packet transmission delay.

In addition, when the bidirectional tunneling-based NEMO Basic Support protocol is applied to the overlapping mobile network, the foregoing inefficient routing of FIGS. 3 and 4 occurs. Therefore, in the foregoing network architecture, a packet size increases due to the duplicate (or overlapping) encapsulation and tunneling, and as a result, a size of a header field required for transmission is excessively larger than an actual data size.

Furthermore, in the conventional technology, in terms of network efficiency, a serious overhead occurs and a packet size increases because of the overlapping encapsulation, and a considerable packet transmission delay occurs according to positions of HAs participating for mobility support, e.g., when positions of the HAs are geographically spaced apart from each other. This is defined as an overlapping-tunnel optimization problem in terms of route optimization, and this problem should necessarily be solved for possible mobility support.

Although the conventional route optimization technology solves the overlapping problem to some extent, it has the bad security problem, which is another problem. If a false MR is located in an intermediate route during packet transmission, the packet can be transmitted to an unauthorized user, which is a fatal problem.

Moreover, in supporting network mobility, the conventional route optimization technology has a route optimization problem that should be solved within a routing infrastructure, in addition to an overlapping optimization problem, where route optimization is reflected in an IP routing structure.

As described above, the route optimization problem can be defined as two problems when only router-class elements are taken into consideration. One is a tunnel optimization problem occurring when mobile networks overlap each other, and the other is a route optimization problem within a routing infrastructure.

In addition, a CN-based route optimization scheme based on Mobile IPv6, in which an increase in number of the CNs increases the number of tunnels between CNs and MRs, is not scalable. Therefore, a problem that an MR searches for a correspondent router (CR) existing in a CN-side network and then forms a bidirectional tunnel between the CR and the MR, is one of the route optimization problems that should necessarily be solved when network mobility is taken into consideration.

Accordingly, there is a demand for a simple, efficient alternative that can be used for solving the route optimization problem occurring in the NEMO support environment.

### SUMMARY OF THE INVENTION

It is, therefore, an object of the present invention to provide a route optimization system and method for reducing a packet transmission delay in a mobile network.

It is another object of the present invention to provide a route optimization system and method for performing efficient routing for improvement of a NEMO Basic Support protocol and mobility support.

It is further another object of the present invention to provide a route optimization system and method for reducing a packet transmission delay by transmitting a packet through an optimized route, rather than through a default tunnel formed between a mobile router and a home agent within a routing infrastructure.

It is yet another object of the present invention to provide a route optimization system and method for reducing unnecessary overhead in a network by optimizing a packet transmission route.

It is still another object of the present invention to provide a simple, efficient route optimization system and method for removing inefficient routing occurring within a routing infrastructure when a Network Mobility (NEMO) Basic Support protocol based on bidirectional tunneling between a mobile router and a home agent is used.

It is still another object of the present invention to provide a route optimization system and method for reducing a packet transmission delay by enabling a packet transmitted where a plurality of mobile routers overlap each other, to directly communicate with a correspondent node without passing through intermediate routes.

It is still another object of the present invention to provide a route optimization system and method for optimizing a complicated transmission route using path control header (PCH) piggybacking when mobile routers coexist in one network, overlapping each other.

According to an aspect of the present invention, there is provided a route optimization method for packet transmission between particular nodes in a mobile network including a plurality of nodes. The method comprises the steps of: receiving, in a predetermined mobile router (MR), a packet transmitted from a predetermined mobile node (MN) connected to its subnet; transmitting, by the MR, the packet to its associated home agent (HA) through a previously established default tunnel; upon receiving the packet, adding, by the HA, registration information of the MR to the packet; transmitting the registration information-added packet from the HA to a correspondent router (CR) of a correspondent node (CN) for which the packet is destined; acquiring, by the CR, registration information of the MR from the received packet; and forming a route-optimized tunnel for packet transmission to the MR according to the acquired information.

According to another aspect of the present invention, there is provided a route optimization method for packet transmission between particular nodes in a mobile network including a plurality of nodes. The method comprises the steps of: receiving a packet from a mobile router (MR) in a home agent (HA); piggybacking, by the HA, a path control header (PCH) representing route information of the MR on the packet; transmitting the PCH-piggybacked packet to a correspondent router (CR) for which the packet is destined; acquiring, by the CR, route information of the MR by analyzing the PCH piggybacked on the packet; performing signaling for route optimization to the MR according to the acquired route information of the MR; and establishing a shortest route for packet transmission between the MR and the CR.

According to further another aspect of the present invention, there is provided a route optimization method for packet transmission in a mobile network having a configuration in which mobile routers (MRs) overlap each other, wherein in a correspondent router (CR) having an overlapping configuration where in a management region of an MR, at least one MR different from the MR constitute a subnet region and perform packet exchange with a plurality of home agents (HAs), a plurality of MRs and the MR, and the mobile network including at least one mobile node (MN) connected to a subnet of each of the plurality of MRs and the CR, and a packet destined for a predetermined MN connected to a subnet of the CR is transmitted from a predetermined MN connected to a subnet of a predetermined MR to the MN connected to the subnet of the CR. The method comprises the steps of: forming, by each MR located in a route for packet transmission between the MN and the CR, a default tunnel to its associated home agent; if a packet from the MR is transmitted through each of the formed default tunnels, piggybacking, by each of the HAs associated with the MRs, a path control header (PCH) obtained by adding address information of its associated MR on the transmitted packet; transmitting a packet on which PCHs of the MRs are piggybacked, to the CR; and upon receiving a packet on which PCHs of the MRs are piggybacked, acquiring, by the CR, address information of all MRs located in a route from the MN to the CN by analyzing PCHs of the MRs included in the packet, and forming a route-optimized tunnel to an MR from which the packet is received, depending on the acquired address information.

According to still another aspect of the present invention, there is provided a route optimization system for packet transmission between particular modes in a mobile network including a plurality of nodes. The system comprises a home agent (HA); and a mobile router (MR) for, if a packet is transmitted from a predetermined mobile node, transmitting the packet to the HA through a previously established default tunnel and optimizing a route to a correspondent router (CR) that transmits the packet, by analyzing a path control header (PCH) included in the packet destined therefore, wherein the HA piggybacks a PCH representing address information of the MR on the packet, and transmits the PCH-piggybacked packet to its associated MR of a correspondent node (CN) for which the packet is destined.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating conventional Mobile IPv6-based network architecture;

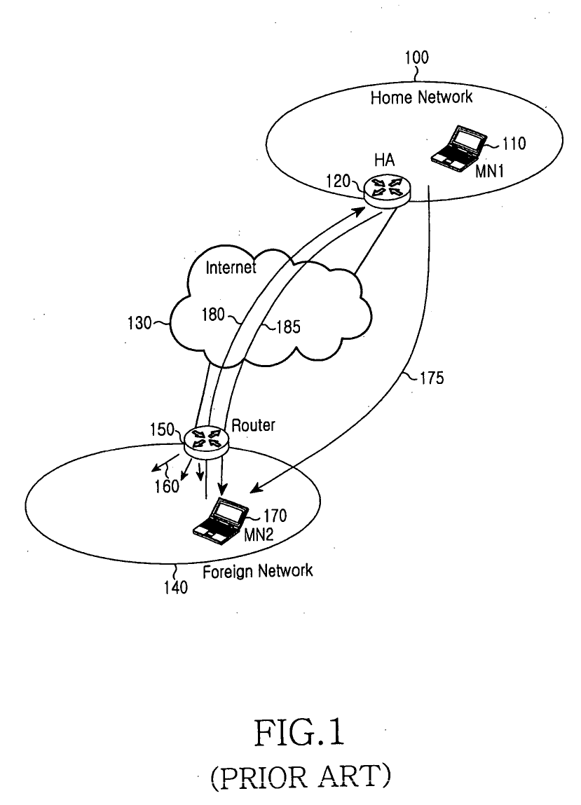

FIG. 2 is a diagram illustrating conventional network architecture using the conventional NEMO Basic Support protocol;

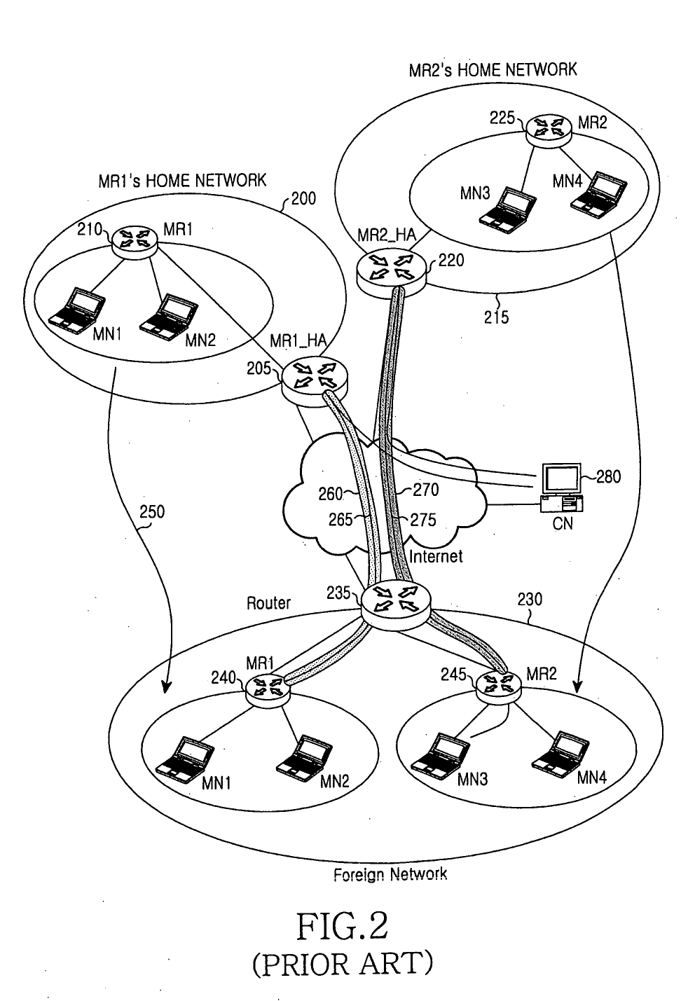

FIG. 3 is a diagram illustrating conventional overlapping network architecture using the conventional NEMO Basic Support protocol;

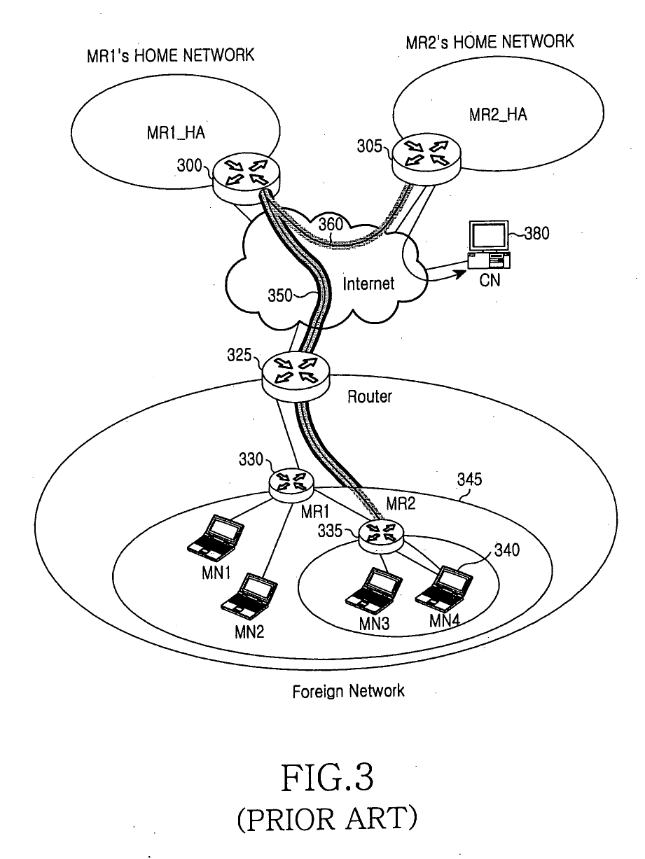

FIG. 4 is a diagram illustrating routes inefficiently established passing through unnecessary nodes in a network using the conventional NEMO Basic Support protocol;

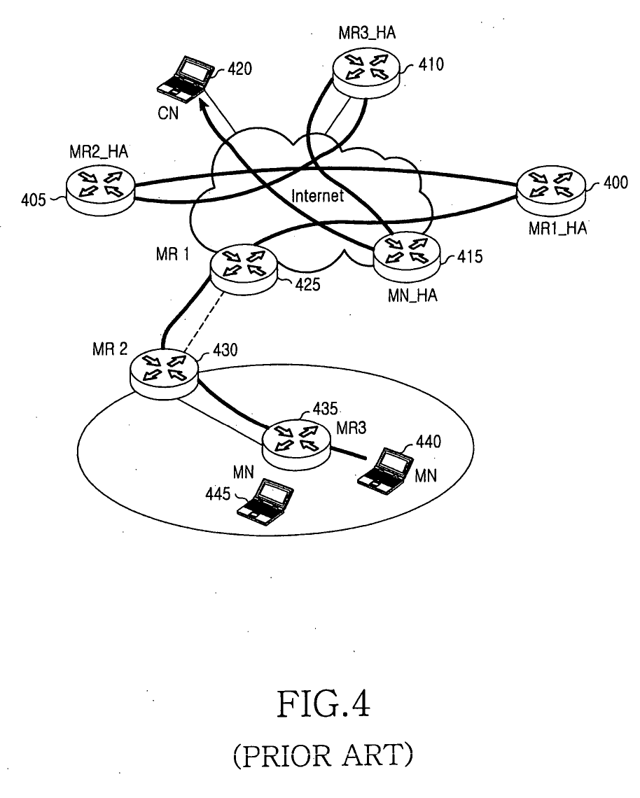

FIG. 5 is a concept diagram illustrating a conventional structure of tunnels formed between an MN to a CN in the overlapping tunnel architecture of FIG. 4;

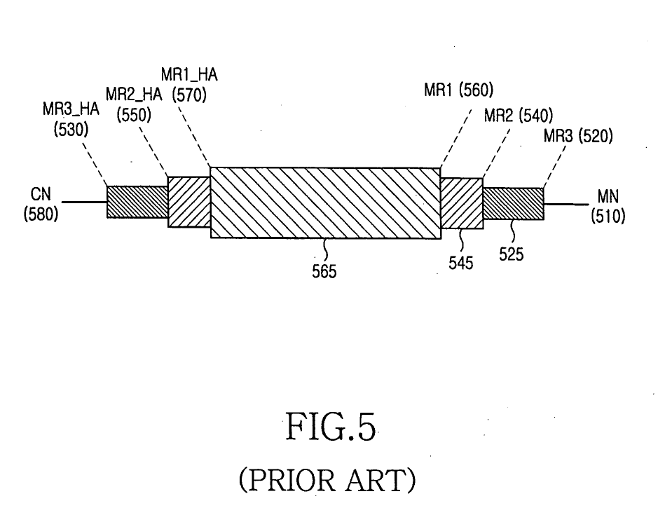

FIG. 6 is a concept diagram illustrating a route optimization method in a mobile network according to an embodiment of the present invention;

FIG. 7 is a diagram illustrating a process of piggybacking a PCH in an HA according to an embodiment of the present invention;

FIG. 8 is a diagram illustrating a PCH structure and information written therein according to an embodiment of the present invention;

FIG. 9 is a diagram illustrating a PCH piggybacking process in a mobile network architecture having overlapping tunnels according to an embodiment of the present invention;

FIG. 10 is a signaling diagram illustrating a procedure for establishing a route-optimized tunnel according to an embodiment of the present invention;

FIG. 11 is a diagram illustrating a format of an additional signaling message according to an embodiment of the present invention;

FIG. 12 is a diagram illustrating CR-based route optimization architecture according to an embodiment of the present invention;

FIG. 13 is a diagram illustrating an MR-to-MR route optimization configuration according to an embodiment of the present invention; and

FIG. 14 is a diagram illustrating a route optimization configuration in overlapping tunnel architecture according to an embodiment of the present invention.

### DETAILED DESCRIPTION OF THE PREFERRED EMBODIMENT

Preferred embodiments of the present invention will now be described in detail herein below with reference to the annexed drawings. In the following description, a detailed description of known functions and configurations incorporated herein has been omitted for conciseness.

However, before a detailed description of the present invention is given, a description will be made of Mobile IPv6 developed to support mobility of an IPv6 host when it moves. Although the Mobile IPv6 can support mobility of a single host like the current mobile network, it has a problem in supporting mobility of unit networks in an intelligent transportation system in which small and large unit networks, such as a personal area network and a mobile vehicle simultaneously move.

As described above, to solve this problem, the Internet Engineering Task Force (IETF), an Internet standard group, has developed Network Mobility (NEMO) technology. However, the NEMO technology developed up to now has an unreasonable routing structure in which if at least one more mobile router (MRs) overlap other MRs, transmission data passes through an unnecessarily long route and many routers. This structure is inefficient in routing as the transmission data should basically pass through a default tunnel between an MR and a home agent (HA).

To solve the above and other problems, the present invention proposes a route optimization apparatus and method for improving Mobile IPv6 proposed to support mobility of a host for IPv6, which is a next generation Internet protocol, a NEMO Basic Support protocol proposed to support NEMO based on the Mobile IPv6, and inefficient routing occurring in supporting mobility. That is, the proposed method is a simple, efficient alternative that can be used for solving a route optimization problem occurring in a NEMO support environment, and can increase packet transmission efficiency by dynamically optimizing a route through functional extension for only such routers as an HA, an MR, and a correspondent router (CR).

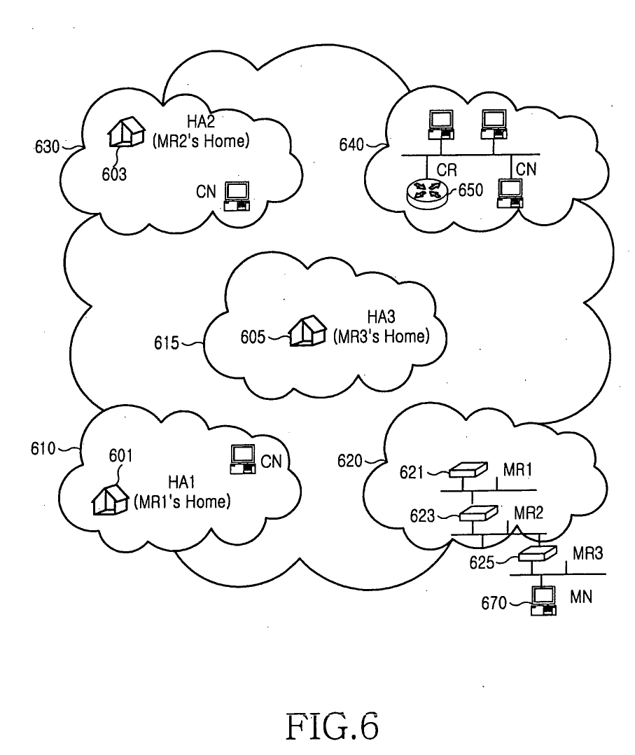

FIG. 6 is a concept diagram illustrating a route optimization method in a mobile network according to an embodiment of the present invention. Referring to FIG. 6, a mobile network includes a plurality of home agents (HAs) HA1 601, an HA2 603, and an HA3 605, a plurality of mobile routers (MRs) MR1 621, an MR2 623 and an MR3 625, a correspondent router (CR) 650, and a plurality of nodes, i.e., a mobile node (MN) 670 and correspondent nodes (CNs).

In FIG. 6, the HA1 601, the HA2 603, and the HA3 605 perform HA function on the MR1 621, the MR2 623, and the MR3 625, respectively. That is, the HA1 601 is an HA for the MR1 621, the HA2 603 is an HA for the MR2 623, and the HA3 605 is an HA for the MR3 625. Accordingly, each HA stores information on its associated MR and stores a table for a binding update each time its associated MR moves.

The MR1 621, the MR2 623, and the MR3 625, which are access routers of the mobile network, control mobility, and support a NEMO system. That is, each of the MRs performs mobility management of its network, and registers its positional information and a mobile network prefix used in the mobile network, in the HA located in its home network, when it moves from a network, or a home network, in which it is originally located, to another network, or a foreign network. In addition, during the location registration, each MR performs a prefix scope binding update, which is a concept extended in Mobile IPv6.

The CR 650, which is a network access router, is a routing facility that participates in route optimization in place of particular CNs belonging to its network. As described above, route optimization in the present invention is achieved with cooperation of such routing devices as HAs, MRs, and CRs.

As illustrated in FIG. 6, the routing devices are located in autonomous systems 610, 615, 620, 630, and 640, which are Internet routing domains. The term “autonomous system” refers to an assemblage of a router and a communication network, which are commonly managed by one management right. The home network and the foreign network belong to the autonomous system. Generally, the Internet is called an assemblage of the autonomous systems.

In the network architecture illustrated in FIG. 6, the access router MR2 623 of the mobile network overlaps the MR1 621 and the MR3 625 overlaps the MR2 623. The CR 650 can be distributed in a random autonomous system. The MN 670 and the CN represent mobile nodes located in the mobile network. However, because the present invention is not limited to this network architecture, the mobile nodes can be replaced with, for example, fixed nodes.

In this architecture, when overlapping tunnels are formed due to overlapping MRs, a transmission packet arrives at its original destination after passing through unnecessary routes in the Internet in the conventional technology. Therefore, it is necessary to set a duplicate overhead and a complicated, inefficient routing path, causing a packet transmission delay.

In order to solve this problem occurring in the foregoing overlapping architecture, the present invention proposes a route optimization method using a path control header (PCH) piggybacking. A description will now be made of the proposed route optimization method in the routing architecture.

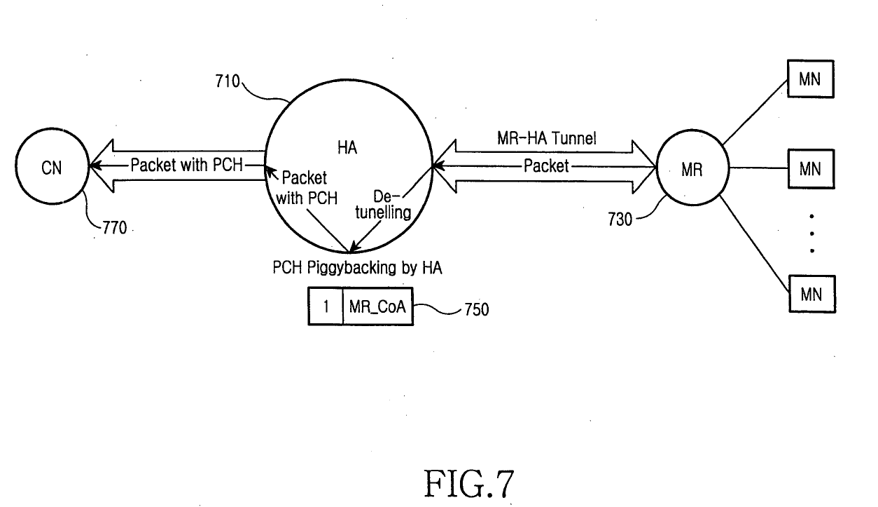

FIG. 7 is a diagram illustrating a process of piggybacking a PCH in an HA according to an embodiment of the present invention. Referring to FIG. 7, the network includes a home agent (HA) 710, a mobile router (MR) 730, a correspondent node (CN) 770, and at least one mobile node (MN).

The HA 710 has registration information of the MR 730, and transmits data to a current position of the MR 730 when the MR 730 has left a home network. The MR 730 controls mobility management, and registers its positional information and a mobile network prefix used in a mobile network, in the HA 710 located in its home network, when it moves from a network, or a home network, in which it was located, to another network, or a foreign network. The CN 770 represents a particular host or router communicating with a particular MN belonging to the MR 730. The MN represents a terminal that is allocated a mobile IP and performs packet data communication with the CN 770 using the allocated mobile IP, and represents a mobile node or a fixed node in a wireless environment.

Reference numeral 750 represents a PCH created in the HA 710. The PCH 750 is a hop-by-hop option header and can be processed by all router devices located in a routing path between the HA 710 and the CN 770. The router devices can include the overlapping HAs or the CR illustrated in FIG. 6.

An MR_CoA for the PCH 750 represents a CoA that the MR 730 is allocated from a foreign network after it moves to a new network, or the foreign network. The hop-by-hop option header is a header defined in IPv6. A router analyzes the hop-by-hop option header when forwarding a packet having the hop-by-hop option header. Therefore, a router based on the IPv6 standard can analyze header contents when forwarding a packet having a PCH header.

A description will now be made of a PCH piggybacking process by the HA 710 in the foregoing architecture.

For route optimization, the HA 710 performs detunneling or decapsulation on a packet transmitted from a particular MN via the MR 730 through a bidirectional tunnel between the MR 730 and the HA 710. Thereafter, the HA 710 piggybacks a PCH on the transmitted packet and transmits the PCH-piggybacked packet to the CN 770.

More specifically, when the HA 710 receives a packet through a tunnel to its MR 730, it piggybacks the PCH 750 including a CoA of a position in which the MR 730 is currently located, i.e., MR_CoA information, on the received packet, and transmits the PCH-piggybacked packet to the CN 770, for route optimization. In this case, a CR (not shown) located in a route from the HA 710 to the CN 770 can form a CR-MR tunnel (hereinafter referred to as an “optimized tunnel” ) using CoA information (MR_CoA) of the MR 730 carried on the PCH 750. Herein, the CR represents a router that can perform route optimization by analyzing the PCH 750. Therefore, the CR can be an HA or an MR.

Alternatively, the CR can be an access router or a border router such as a border gateway protocol (BGP) router.

The PCH, as described above, is added to a header in an IPv6 packet as an option header. Generally, a function of a header can be added to an IPv6 basic function by inserting a function added in the form of an option message into an option header field of the header. Therefore, the method of inserting a PCH option header by piggybacking, proposed in the present invention, writes a PCH option header in an option header field determined according to IPv6 header rule by detunneling a header of a given packet.

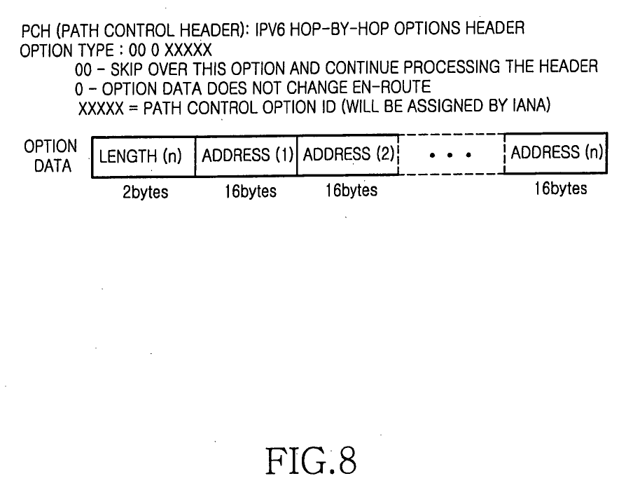

FIG. 8 is a diagram illustrating a PCH structure and information written therein according to an embodiment of the present invention. Referring to FIG. 8, the PCH (Path Control Header) is an IPv6 hop-by-hop option header and has address information as option data. Herein, the address information is expressed as a list of IPv6 addresses. An address delivered through the PCH becomes a CoA of an MR in an HA-MR relation, and a CR acquires the CoA of the MR through the PCH.

More specifically, FIG. 8 illustrates a structure of an option type defined in IPv 6. As illustrated in FIG. 8, among a total of 8 bits, i.e., 00 0 xxxxx, 5 LSB bits(xxxxx) represent an identifier (ID) indicating the PCH and 3 MSB bits(00 0) are used for designating a processing way of a router for the hop-by-hop option header.

As illustrated in FIG. 8, the PCH structure according to an embodiment of the present invention includes a Length field and a plurality of Address fields. The Length field represents a length of data including its succeeding fields of Address(1) to Address(n) in bytes to indicate a length of the corresponding PCH option header.

The word ‘Bytes’ shown in FIG. 8 represents a size of each field. For example, the Length field has 2 bytes and has an integer value of 0 to 65536. In addition, a value of the Length field represents the total length of the PCH header.

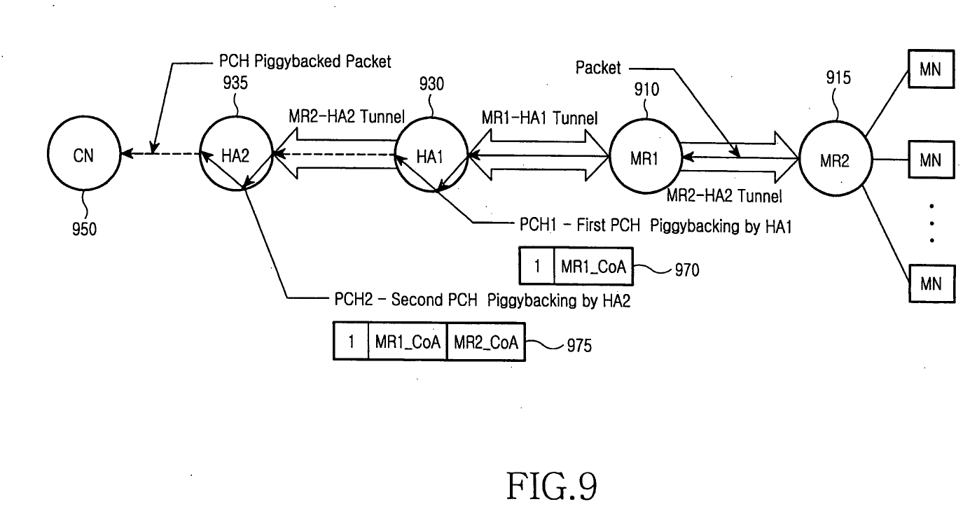

The Address fields following the Length field sequentially write therein CoA information of MRs, carried by the PCH option header. That is, an HA receiving the PCH option header, first writes a CoA address of an MR to which its own tunnel is formed, in the end of an Address field in the received PCH option header. A detailed method of using the PCH header will be described with reference to FIG. 9.

FIG. 9 is a diagram illustrating a PCH piggybacking process in a mobile network architecture having overlapping tunnels according to an embodiment of the present invention. Referring to FIG. 9, the mobile network includes a plurality of home agents HA1 930 and an HA2 935, a plurality of mobile routers MR1 910 and MR2 915, a correspondent node CN 950, and a plurality of mobile nodes (MNs).

In FIG. 9, overlapping tunnels are formed, i.e., the MR2 915 overlaps the MR1 910, and a data packet is transmitted from a particular MN connected to the MR2 915 is transmitted to the CN 950. The HA1 930 is an HA for the MR1 910, and the HA2 935 is an HA for the MR2 915. The HA1 930 and the HA2 935 store information on the MR1 910 and the MR2 915, respectively, and each time the MRs 910 and 915 move, the HA1 930 and the HA2 935 each store a table for a binding update.

A PCH1 970 represents a first PCH piggybacked by the HA1 930 and PCH2 975 represents a second PCH piggybacked by the HA2 935. The PCH carries a CoA for each of the MR1 910 and the MR2 915. That is, the PCH1 970 piggybacked by the HA1 930 carries a CoA for the MR1 910, i.e., MR1_CoA, and the PCH2 975 piggybacked by the HA2 935 carries the MR1_CoA and a CoA for the MR2 915, i.e., MR2_CoA. The HA2 935 identifies that its own MR2 915 overlaps the MR1 910, by analyzing a packet having the PCH1 970 piggybacked from the HA1 930.

In this overlapping architecture, the HA2 935 adds only a CoA of its MR to a PCH delivered from an upper tunnel when piggybacking a PCH. Referring to FIG. 9, the HA2 935 further adds a CoA of the MR2 915, i.e., the MR2_CoA, to the PCH1 970 delivered from an upper tunnel, i.e., the MR1-HA1 tunnel.

The HA2 935 piggybacks the PCH2 975 having a CoA, MR1_CoA, of the MR1 910, which is an end of an upper MR1-HA1 tunnel and a CoA, MR2_CoA, of the MR2 915, which is an end of its own MR2-HA2 tunnel. Subsequently, the MR1_CoA is delivered to the CN 950 together with the MR2_CoA created by the HA2 935. The MR1_CoA and MR2_CoA information can be used for establishing a route-optimized tunnel by a CR (not shown) located in a route from the HA2 935 to the CN 950.

For a packet delivered to an HA through an MR-HA bidirectional tunnel for route optimization, its PCH should be basically piggybacked. In this case, the HA can determine whether to continuously perform piggybacking on the packet, considering a source and a destination of the packet. If, even though a predetermined time has elapsed, a packet having the same source and destination is continuously delivered from an MR-HA tunnel, the HA no longer performs PCH piggybacking, determining that there is no CR in an HA-CN route. That is, if a route of a packet destined for the same destination does not change, even though a previous packet underwent PCH piggybacking, it is not necessary to perform PCH piggybacking any longer because there is no router (CR) capable of analyzing PCH in an HA-CN route.

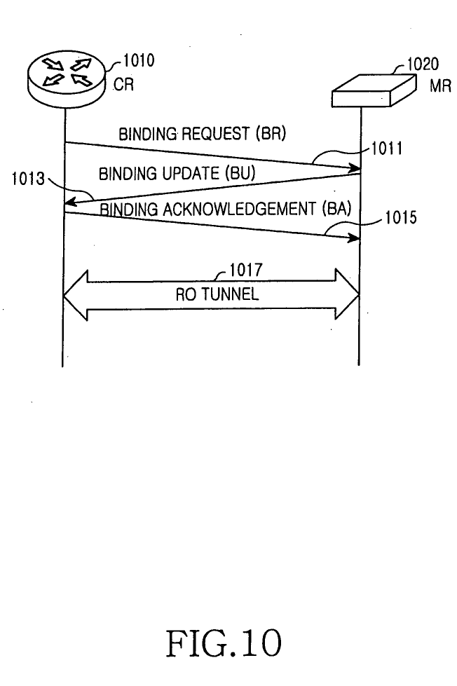

FIG. 10 is a signaling diagram illustrating a procedure for establishing a route-optimized tunnel according to an embodiment of the present invention. Referring to FIG. 10, if a particular CR 1010 desires to request a particular MR 1020 for binding update, it transmits a binding request to the MR 1020 using a Binding Request (BR) message in Step 1011.

The MR 1020 should transmit a new binding update (BU) before a lifetime of binding information expires. However, if the CR 1010 receives no binding update from the MR 1020 until its timer is about to expire during data exchange, the CR 1010 transmits a binding update request to the MR 1020. A binding update from an MR is periodically achieved, but a CR is not required to verify if the binding update contents are continuously effective. That is, if binding update is not achieved within a predetermined lifetime, the CR can request the MR for binding update.

The MR 1020 receiving the binding request transmits a binding update through a Binding Update (BU) message in order to provide current binding information to the CR 1010 with which it is currently communicating in Step 1013. All packets including the Binding Update message require a data authentication mechanism to protect the binding update from malicious binding update. The malicious binding update and the data authentication mechanism are required in Mobile IPv6. Because falsification of the binding update may generate a serious problem, there are demands for authentication and integrity guarantee on the binding update contents.

Upon receiving the binding update from the MR 1020, the CR 1010 transmits a binding acknowledgement to the MR 1020 using a Binding Acknowledgement (BA) message to acknowledge receipt of the binding update in Step 1015. Similarly, all packets including the binding acknowledgement require a data authentication mechanism to protect the binding acknowledgement from malicious binding update.

Finally, if the binding acknowledgement is used in the CR 1001, a route-optimized (RO) tunnel is formed between the CR 1010 and the MR 1020 in Step 1017.

The route-optimized tunnel forming process can be summarized as follows.

The CR 1010, after acquiring a CoA of the MR 1020 through a PCH, can form a route-optimized tunnel, and a signaling for forming a route-optimized tunnel between the CR 1010 and the MR 1020 can be achieved by, for example, a 3-way handshake as illustrated in FIG. 10. The messages used between the CR 1010 and the MR 1020 are included in a Mobility Header field defined in Mobile IPv6 before being transmitted.

However, the Binding Request message in step 1011 is a new message proposed by the present invention, and is used for informing the MR 1020 of a need for forming a tunnel for which route optimization is considered. The Binding Update message in step 1013 and the Binding Acknowledgement message in step 1015 are equal to those defined in Mobile IPv6 and NEMO.

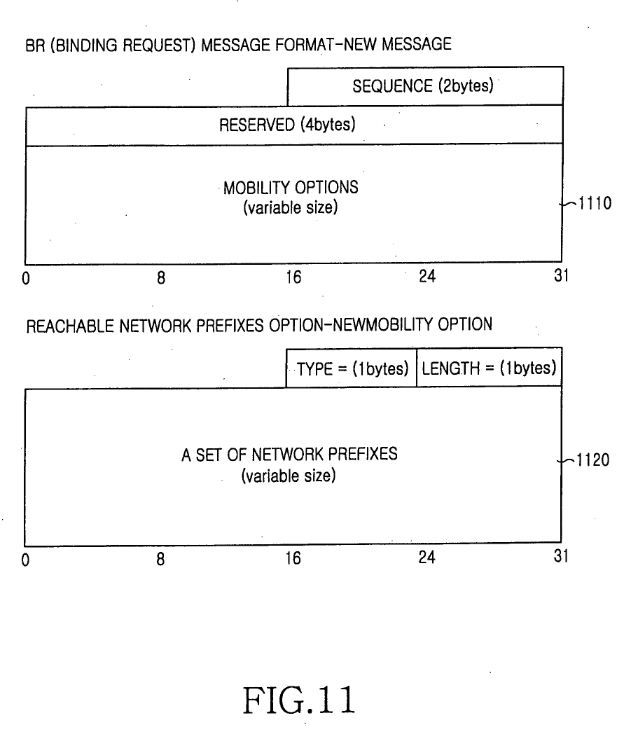

The present invention defines a new additional signaling message, i.e., the Binding Request message, used for informing the MR 1020 of reachable network information, i.e., a set of prefixes, managed by the CR 1010. With reference to FIG. 11, a description will now be made of a format of the Binding Request message newly proposed in the present invention.

FIG. 11 is a diagram illustrating a format of an additional signaling message according to an embodiment of the present invention. Referring to FIG. 11, the additional signaling message, i.e., the Binding Request message, represents a mobility message capable of using mobility options defined in Mobile IPv6. The Binding Request message includes a Mobility Option field 1110 defined for informing an MR of reachable network information managed by a CR. The Mobility Option field 1110 has a variable size.

The new Mobility Option field 1110 is defined as a Reachable Network Prefixes Mobility Option 1120. The prefix information is checked by an MR during reverse packet transmission. During reverse transmission, a packet having a destination belonging to a prefix related to a route-optimized tunnel passes through the route-optimized tunnel 1017 of FIG. 10.

In FIG. 10, the CR also acquires mobile network prefix information through the Binding Update message 1013. Thereafter, the CR transmits a packet using the acquired mobility network prefix information. That is, if a destination of a packet delivered from a particular CN belongs to the acquired mobile network prefix, the CR delivers the packet through the route-optimized tunnel 1017. A format of a message included in the fully optimized signaling is illustrated in FIG. 11.

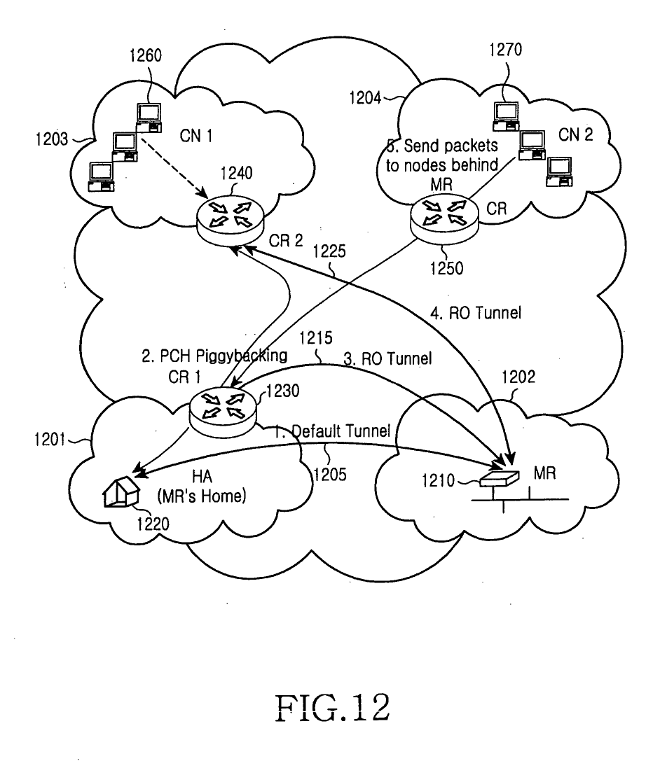

FIG. 12 is a diagram illustrating CR-based route optimization architecture according to an embodiment of the present invention. However, before a description of FIG. 12 is given, it is assumed in FIG. 12 that a packet destined for a particular CN is transmitted beginning at an MR. However, the present invention is not limited to the assumption, and the packet is transmitted beginning at a particular MN belonging to the MR.

Referring to FIG. 12, reference numeral 1220 represents a home agent (HA), and the home agent 1220 is an HA for an MR 1210. The MR 1210 is an access router of a mobile network, and controls mobility. Reference numerals CR1 (1230), CR2 (1240), and CR (1250) represent network access routers, and participate in route optimization in place of particular CNs belonging to the network.

Reference numerals 1201, 1202, 1203, and 1204 represent autonomous systems, which are Internet routing domains, and the foregoing routing facilities are located in the autonomous systems.

A description will now be made of a route optimization process by a CR in the foregoing architecture according to an embodiment of the present invention.

To provide transparent route optimization service to a particular CN as illustrated in FIG. 12, the present invention introduces the CR. The CR maintains information on a mobile prefix cache, which is a table for managing a prefix for a mobile network, intercepts a packet transmitted by the CN before the packet arrives at the HA, and directly delivers the intercepted packet to the MR. That is, when the CR is used, the MR can receive packets transmitted by a plurality of CNs, through one CR-MR tunnel, and the MR can use the tunnel even during reverse routing.

In the route optimization, because all processes related to Mobile IPv6 and NEMO are transparently achieved by the routing facilities, i.e., the MR, the HA and the CR, all nodes belonging to nodes of a mobile network and the network of the CR can be Simple IPv6 nodes.

More specifically, the following description will be made on the assumption that a data packet is transmitted from the MR 1210 to the CN1 1260 as illustrated in FIG. 12. The HA 1220 first forms a default tunnel 1205 for the MR 1210. Thereafter, the MR 1210 delivers the packet up to the HA 1220 through the established default tunnel 1205. The HA 1220 performs PCH piggybacking on the delivered packet, and delivers the PCH-piggybacked packet to a CR2 1240 via a CR1 1230. The CR2 1240 delivers the packet received from the MR 1210 via the CR1 1230, to the CN1 1260, complicating packet delivery.

The CR1 1230 and the CR2 1240 acquire CoA of the MR 1210 by checking a packet having a PCH piggybacked by the HA 1220, and form optimized routes to the MR 1210 using the acquired CoA.

That is, the CR1 1230 and the CR2 1240 can establish route-optimized tunnels 1215 and 1225 to the MR 1210 through PCH piggybacking by the HA 1220 as illustrated in FIG. 12.

In FIG. 12, the CR2 1240 establishes the route-optimized tunnel 1225 to the MR 1210. Additionally, the CR1 1230 can also establish a route-optimized tunnel when necessary. When the CR1 1230 and the CR2 1240 establish the route-optimized tunnels, a route for a packet sent from every CN 1260 located in a subnet of the CR2 1240 is optimized by the CR2 1240.

However, when there is no closer CR, e.g., a CR 1250, every CN2 1270 located in an autonomous system 1204 can receive route-optimized service by at least the CR1 1230.

A detailed description will now be made of a route optimization process using a CR.

If a particular CN1 1260 transmits a packet to the CR2 1240, the CR2 1240 transmits the received packet to the CR1 1230. The CR1 1230 receives the transmitted packet and delivers the received packet to the HA 1220. The HA 1220 transmits the packet to the MR 1210 and then forms a tunnel to the MR 1210. Thereafter, the HA 1220 performs PCH piggybacking on the packet and transmits the PCH-piggybacked packet to the CR1 1230. The PCH-included packet transmitted to the CR1 1230 is transmitted to the CN1 1260 via the CR2 1240.

The CR1 1230 analyzes the packet PCH-piggybacked by the HA 1220, and acquires information on the MR 1210 using the analysis result. Thereafter, the CR1 1230 forms a route-optimized tunnel 1215 between the CR1 1230 and the MR 1210 through signaling for forming a route-optimized tunnel.

The CR2 1240 also analyzes a PCH-piggybacked packet delivered from the HA 1220 via the CR1 1230, and acquires information on the MR 1210 using the analysis result. Thereafter, the CR2 1240 forms a route-optimized tunnel 1225 between the CR2 1240 and the MR 1210 through signaling for forming a route-optimized tunnel.

The CN2 1270, if there is no CR located in a position adjacent thereto, performs route-optimized service through a CR closest thereto. For example, it will be assumed in FIG. 12 that a CR closest to the CN2 1270 is the CR1 1230. That is, the CN2 1270, if there is no CR to which it belongs, performs route optimization through at least the CR1 1230. Therefore, if the CN2 1270 transmits a packet to the CR1 1230, the CR1 1230 transmits the packet to the MR 1210 through the tunnel 1215 formed to the MR 1210.

The MR 1210 transmits the received packet through the default tunnel 1205 formed to the HA 1220, and the HA 1220 performs PCH-piggybacking on the packet and then transmits the PCH-piggybacked packet to the CR2 1270. Therefore, the CN2 1270 can receive route-optimized service through the CR1 1230. That is, in the proposed CR-based route optimization method, the route-optimized tunnel 1215 is formed between the CR1 1230 and the MR 1210 and the route-optimized tunnel 1225 is formed between the CR2 1240 and the MR 1210 through the PCH piggybacking. After the route-optimized tunnels 1215 and 1225 are formed in this manner, packet transmission is achieved with the shortest distance through the route-optimized tunnels 1215 and 1225.

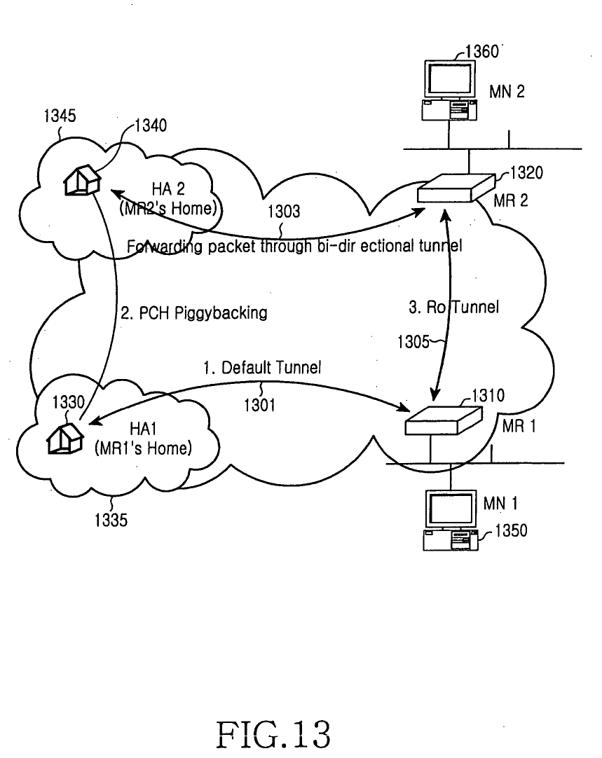

FIG. 13 is a diagram illustrating an MR-to-MR route optimization configuration according to an embodiment of the present invention. Referring to FIG. 13, reference numerals HA1 (1330) and HA2 (1340) represent home agents, are HAs for the MR1 1310 and an HA for the MR2 1320, respectively. That is, the HA1 1330 is an HA for the MR1 1310, and the HA2 1340 is an HA for the MR2 1320. The MR1 1310 and the MR2 1320, which are access routers of a mobile network, have mobility and perform a function basically defined in the NEMO system. Reference numerals 1335 and 1345 represent autonomous systems, which are Internet routing domains, and reference numerals MN1 (1350) and MN2 (1360) represent mobile nodes or fixed nodes located in the mobile network.

A description will now be made of a situation in which a packet is exchanged between the MR1 1310 and the MR2 1320 which are access routers of the mobile network, e.g., a situation in which a packet is transmitted from the MR1 1310 to the MR2 1320.

In FIG. 13, if the MN1 1350 transmits a packet targeting (or destined for) the MN2 1360, the packet transmitted from the MN1 1350 is first received at the MR1 1310, and then delivered to the HA1 1330 through an MR1-HA1 default tunnel 1310. The HA1 1330 creates a packet including a PCH by piggybacking the PCH on the received packet, and delivers the created PCH-included packet to the HA2 1340 through IP routing. Thereafter, the HA2 1340 receiving the PCH-included packet tunnels (or forwards) the received PCH-included packet to the MR2 1320 through a previously formed MR2-HA2 default tunnel 1303.

Upon receiving the PCH-piggybacked packet, the MR2 1320 identifies the presence of the MR1 1310 through a PCH included in the packet, and acquires a CoA of the MR1 1310 by analyzing the PCH. Subsequently, the MR2 1320 performs a signaling procedure for route optimization through the CoA of the MR1 1310, forming a route-optimized tunnel 1305 between the MR1 1310 and the MR2 1320. Packets delivered after the route-optimized tunnel 1305 between the MR1 1310 and the MR2 1320 is formed, i.e., all packets between the MN1 1350 and the MN2 1360, are delivered through the route-optimized tunnel 1305.

Above, a description has been made of a process for transmitting a packet from the MR1 1310 to the MR2 1320. However, a description will now be made of a process of transmitting a packet from the MR2 1320 to the MR1 1310.

In FIG. 13, if the MN2 1360 transmits a packet destined for the MN1 1350, the packet transmitted from the MN2 1360 is first received at the MR2 1320, and then delivered to the HA2 1340 through the MR2-HA2 default tunnel 1303. The HA2 1340 performs PCH piggybacking on the received packet. Thereafter, the HA2 1340 delivers the PCH-included packet to the HA1 1330 through IP routing. The HA1 1330 receiving the PCH-included packet tunnels the received PCH-included packet to the MR1 1310 through the previously formed MR1-HA1 default tunnel 1301.

Upon receiving the PCH-piggybacked packet, the MR1 1310 identifies the presence of the MR2 1320 through a PCH included in the packet, and acquires a CoA of the MR2 1320 by analyzing the PCH. Thereafter, the MR1 1310 performs a signaling procedure for route optimization with the CoA of the MR2 1320, and forms a route-optimized tunnel 1305 between the MR2 1320 and the MR1 1310 according to the signaling result. Therefore, packets delivered after the route-optimized tunnel 1305 between the MR2 1320 and the MR1 1310 is formed, i.e., all packets between the MN1 1350 and the MN2 1360, are delivered through the route-optimized tunnel 1305.

As described above, an MR analyzes a PCH piggybacked on a packet, checks a route-optimized tunnel between MRs according to the PCH analysis result, and establishes a route-optimized tunnel between MRs according to the check result. Accordingly, it is possible to exchange packets between mobile networks through the shortest route.

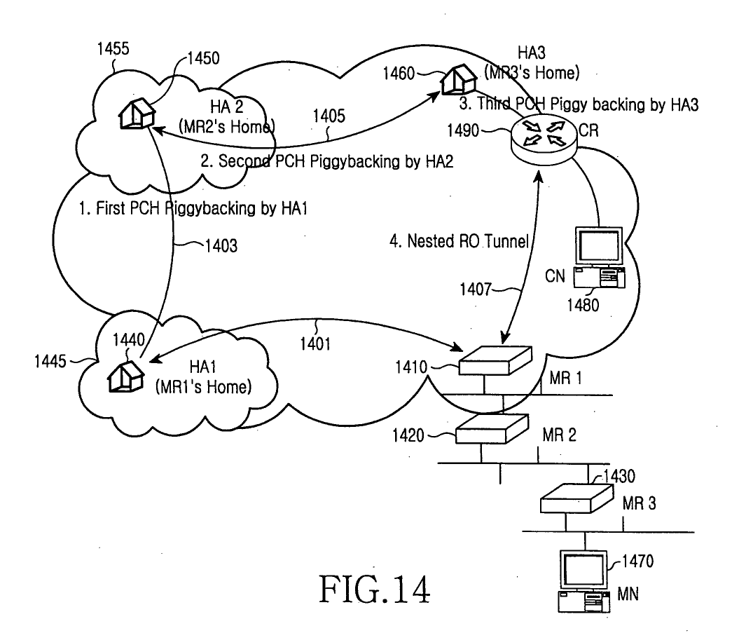

FIG. 14 is a diagram illustrating a route optimization configuration in the overlapping tunnel architecture according to an embodiment of the present invention. Referring to FIG. 14, reference numerals HA1 (1440), HA2 (1450), and HA3 (1460) are HAs for an MR1 1410, an MR2 1420, and an MR3 1430, respectively. The MR1 1410, the MR2 1420, and the MR3 1430 are access routers of a mobile network, and have mobility. A CR 1490, a network access router, can participate in route optimization in place of a particular CN 1480 belonging to the network. An MN 1470 represents a mobile node or a fixed node located in the mobile network. Reference numerals 1445 and 1455 represent autonomous systems in which the HA1 1440 and the HA2 1450 are located, respectively.

In the forgoing network architecture, the MR2 1420 overlaps the MR1 1410 and the MR3 1430 overlaps the MR2 1420. A description will now be made of a route optimization method in the overlapping tunnel architecture according to an embodiment of the present invention. In the process of FIG. 14, the MN 1470 communicates with the CN 1480.

The NEMO Basic Support technology has a basic mechanism in which each of MRs forms a tunnel between the MR itself and its HA, and transmits a packet destined from its subnet to the outside, via the HA through the formed tunnel.

In FIG. 14, when the MN 1470 desires to communicate with the CN 1480, an MR3-HA3 tunnel, an MR2-HA2 tunnel, and an MR1-HA1 tunnel should be formed for the MR3 1430, the MR2 1420, and the MR3 1410, respectively. That is, as illustrated in FIG. 14, basically, the MR1 1410 creates an MR1-HA1 tunnel 1401 to its own HA1 1440, the MR2 1420 creates an MR2-HA2 tunnel 1403 to its own HA2 1450, and the MR3 creates an MR3-HA3 tunnel 1405 to its own HA3 1460.

As illustrated in FIG. 14, the MR2 1420 is located in a subnet of the MR1 1410, and the MR3 1430 is located in a subnet of the MR2 1420. Therefore, the MR2 1420 should transmit a packet transmitted from the MR3 1430 through its MR2-HA2 tunnel 1403, and the MR1 1410 should transmit a packet transmitted from the MR2 1420 through its MR1-HA1 tunnel 1401. That is, the MR3-HA3 tunnel 1405 formed between the MR3 1430 and the HA3 1460 is connected through the MR2-HA2 tunnel 1403 between the MR2 1402 and the HA2 1450 and the MR1-HA1 tunnel 1401 between the MR1 1410 and the HA1 1440.

That is, a packet destined from the MN 1470 to the CN 1480 undergoes first tunneling at the MR3 1430 through the MR3-HA3 default tunnel 1405, second tunneling at the MR2 1420 through the MR2-HA2 default tunnel 1403, and third tunneling at the MR1 1410 through the MR1-HA1 default tunnel 1401.

First, the tunneled packet is decapsulated in the HA1 1440, during which a PCH1 is piggybacked. Second, the tunneled packet is decapsulated again in the HA2 1450, during which a PCH2 is piggybacked. Finally, the tunneled packet is decapsulated again in the HA3 1460, during which a PCH 3 is piggybacked.

The PCH1 represents a first PCH piggybacked by the HA1 1440, the PCH2 represents a second PCH piggybacked by the HA2 1450, and the PCH 3 represents a third PCH piggybacked by the HA3 1460. The first PCH, the second PCH, and the third PCH carry a CoA for the MR1 1410, a CoA for the MR2 1420, and a CoA for the MR3 1430, respectively.

The HA2 1450 analyzes a packet having a PCH1 piggybacked by the HA1 1440, and based on the analysis result, determines that its own MR2 1420 overlaps the MR1 1410. The HA3 1460 analyzes a packet having a PCH2 piggybacked by the HA2 1450, and based on the analysis result, determines that its own MR3 1430 overlaps the MR2 1420. The CN 1480 acquires CoA information of the MR3 1430 by analyzing a packet having a PCH 3 piggybacked by the HA3 1460.

In the foregoing overlapping configuration, each of the HA2 1450 and the HA3 1460 further adds only a CoA of its own MR to a PCH delivered from its upper tunnel in the process of piggybacking the PCH.

The HA2 1450 piggybacks a PCH2 having a CoA (MR1_CoA) of the MR1 1410, which is an end of its upper tunnel, and a CoA (MR2_CoA) of the MR2 1420, which is an end of its own tunnel. Therefore, the PCH2 includes therein MR1_CoAIMR2_CoA information determined by further adding MR2_CoA information to MR1_CoA information for the PCH1 by the HA2 1450, before being transmitted to the HA3 1460.

The HA3 1460 piggybacks a PCH 3 having the CoAs (MR_CoA|MR2_CoA) of the MR1 1410 and the MR2 1420 and a CoA (MR3_CoA) of the MR3 1430, which is an end of its own tunnel. Therefore, the PCH 3 delivers MR1_CoA|MR2_CoA|MR3_CoA information determined by further adding the MR3_CoA information to the MR1_CoA|MR2_CoA information of the PCH2 by the HA3 1460, to the CN 1480 via the CR 1490.

Finally, a packet having the PCH 3 arrives at the CN 1480 via the CR 1490. The CR 1490 acquires overlapping route information such as MR1 (1410)→MR2 (1420)→MR3 (1430) through the PCH 3, and then forms a nested route-optimized tunnel 1407 based on the information.

A detailed description will now be made of a route optimization process in the overlapping tunnel architecture.

As illustrated in FIG. 14, a first packet delivered by the MN 1470 is first tunneled at the MR3 1430 through the MR3-HA3 default tunnel, next tunneled at the MR2 1420 through the MR2-HA2 default tunnel, and finally tunneled at the MR1 1410 through the MR1-HA1 default tunnel.

The 3-level tunneled packet is decapsulated at the HA1 1440, during which a first PCH, PCH1, is piggybacked. Next, the 3-level tunneled packet is decapsulated at the HA2 1450, during which a second PCH, PCH2, is piggybacked. Thereafter, the 3-level tunneled packet is decapsulated at the HA3 1460, during which a third PCH, PCH 3, is piggybacked.

A packet having the PCH 3 arrives at the CN 1480 via the CR 1490. The CR 1490 acquires overlapping route information such as MR1 (1410)→MR2 (1420)→MR3 (1430) through the PCH 3, and then forms the nested route-optimized tunnel 1407 depending on the information.

The CR 1490, after forming the nested route-optimized tunnel 1407 to the MR3 1430, performs source routing to pass through the formed route-optimized tunnel. The “source routing” will now be described herein below.

In general routing, a router checks a prefix part using a destination address field of a packet. Thereafter, the router compares the prefix with its routing table, and based on comparison result, determines to which point it will forward next packets having the corresponding prefix. However, in source routing, a router checks all addresses up to the destination address, instead of consulting only a prefix part without consulting addresses up to the final destination address, and based on the check result, determines to which point it will forward a packet having the corresponding destination address. Therefore, the source routing method can designate a detailed routing path for each IP address. Through the source routing, a bidirectional-optimized route of CR (1490)→MR1 (1410)→MR2 (1420)→MR3 (1430) is acquired.

As described above, the proposed route optimization method using piggybacking in a mobile network provides a simple, effective method that can be used for solving a route optimization problem occurring in the NEMO support environment.

Further, the proposed route optimization method can dynamically optimize a route through functional extension of only particular routers such as a home agent (HA), a mobile router (MR), and a correspondent router (CR), and in this manner, can acquire higher optimization efficiency compared with the route optimization method between a CR and a MR based on the conventional Mobile IPv6.

The PCH piggybacking scheme according to the present invention, as a general access scheme for route optimization, can be used for simultaneously solving various optimization problems, and can achieve route optimization in various situations such as a CR-based route optimization problem or a tunnel optimization problem in the overlapping architecture.

In addition, the present invention can acquire an optimization-considered tunnel in a CR-based environment, an MR-MR environment, and overlapping environment, using piggybacked PCH information. Additionally, the use of the optimization-considered tunnel can achieve packet delivery through an optimized routing path.

Moreover, the present invention can reduce packet transmissions and reduce overhead in a nested NEMO environment.

While the present invention has been shown and described with reference to certain preferred embodiments thereof, it will be understood by those skilled in the art that various changes in form and details may be made therein without departing from the spirit and scope of the present invention as defined by the appended claims.

1. A route optimization method for packet transmission between particular nodes in a mobile network including a plurality of nodes, the method comprising the steps of:
receiving, in a predetermined mobile router (MR), a packet transmitted from a predetermined mobile node (MN) connected to its subnet;
transmitting, by the MR, the packet to its associated home agent (HA) through a previously established default tunnel;
upon receiving the packet, adding, by the HA, registration information of the MR to the packet;
transmitting the registration information-added packet from the HA to a correspondent router (CR) of a correspondent node (CN) for which the packet is destined;
acquiring, by the CR, registration information of the MR from the received packet; and
forming a route-optimized tunnel for packet transmission to the MR according to the acquired information.

2. The route optimization method of claim 1, wherein if a packet is transmitted from the MR, the HA searches its own table for registration information corresponding to the MR, and generates a new packet by adding the searched registration information of the MR to the packet.

3. The route optimization method of claim 1, wherein the registration information of the MR is a care-of-address (CoA) having route information of the MR.

4. The route optimization method of claim 1, wherein the route-optimized tunnel is a shortest route for packet transmission between the MN and the CN.

5. The route optimization method of claim 1, wherein after the route-optimized tunnel is formed, packet transmission between the MN and the CN is achieved through the formed route-optimized tunnel.

6. A route optimization method for packet transmission between particular nodes in a mobile network including a plurality of nodes, the method comprising the steps of:
receiving a packet from a mobile router (MR) in a home agent (HA);
piggybacking, by the HA, a path control header (PCH) representing route information of the MR on the packet;
transmitting the PCH-piggybacked packet to a correspondent router (CR) for which the packet is destined;
acquiring, by the CR, route information of the MR by analyzing the PCH piggybacked on the packet;
performing signaling for route optimization to the MR according to the acquired route information of the MR; and
establishing a shortest route for packet transmission between the MR and the CR.

7. The route optimization method of claim 6, wherein if a packet is transmitted from the MR, the HA searches its own table for route information corresponding to the MR, and piggybacks a PCH having the searched route information of the MR on the packet.

8. The route optimization method of 6, wherein the route information of the MR is a care-of-address (CoA) of the MR.

9. The route optimization method of claim 6, wherein after the shortest route is established, packet transmission between the MR and the CR is achieved through the established shorted route.

10. The route optimization method of claim 6, wherein the CR includes an HA, an MR, an access router (AR), and a border router (BR), and performs route optimization by analyzing the PCH.

11. The route optimization method of claim 6, wherein the PCH is a hop-by-hop option header.

12. The route optimization method of claim 6, wherein the PCH includes address information as option data, and the address information is a CoA of the MR.

13. The route optimization method of claim 6, wherein the step of performing the signaling for route optimization comprises the steps of:
upon acquiring the route information of the MR from the PCH, transmitting, by the CR, a binding request message for binding update request to the MR;
upon receiving the binding request message, transmitting, by the MR, a binding update message for providing current binding information to the CR with which the MR currently communicates;
upon receiving the binding update message, transmitting, by the CR, a binding acknowledgement message for acknowledging receipt of the binding update message; and
after transmitting the binding acknowledgement message, forming a route-optimized tunnel between the CR and the MR.

14. The route optimization method of claim 13, further comprising the step of performing a data authentication mechanism on all packets including the binding update message and the binding acknowledgement message.

15. The route optimization method of claim 13, wherein the binding request message informs the MR of a need for forming a route-optimized tunnel.

16. The route optimization method of claim 13, wherein the CR transmits the binding request message, if the CR, during data exchange with the MR, fails to receive the binding update message from the MR before a predetermined time expires.

17. The route optimization method of claim 13, wherein the binding request message includes a mobility option field for informing the MR of reachable network information managed by the CR.

18. The route optimization method of claim 17, wherein the reachable network information is a set of prefixes.

19. The route optimization method of claim 17, wherein the mobility option field is as a reachable network prefixes mobility option and has a variable size.

20. A route optimization method for packet transmission in a mobile network having a configuration in which mobile routers (MRs) overlap each other, wherein in a correspondent router (CR) having an overlapping configuration where in a management region of an MR, at least one MR different from the MR constitute a subnet region and perform packet exchange with a plurality of home agents (HAs), a plurality of MRs and the MR, and the mobile network including at least one mobile node (MN) connected to a subnet of each of the plurality of MRs and the CR, and a packet destined for a predetermined MN connected to a subnet of the CR is transmitted from a predetermined MN connected to a subnet of a predetermined MR to the MN connected to the subnet of the CR, the method comprising the steps of:
forming, by each MR located in a route for packet transmission between the MN and the CR, a default tunnel to its associated home agent;
if a packet from the MR is transmitted through each of the formed default tunnels, piggybacking, by each of the HAs associated with the MRs, a path control header (PCH) obtained by adding address information of its associated MR on the transmitted packet;
transmitting a packet on which PCHs of the MRs are piggybacked, to the CR; and
upon receiving a packet on which PCHs of the MRs are piggybacked, acquiring, by the CR, address information of all MRs located in a route from the MN to the CN by analyzing PCHs of the MRs included in the packet, and forming a route-optimized tunnel to an MR from which the packet is received, depending on the acquired address information.

21. The route optimization method of claim 20, wherein the address information is a care-of-address (CoA) of the MR.

22. The route optimization method of claim 20, wherein after the route-optimized tunnel is formed, packet transmission from the MN to the CN is achieved through the formed route-optimized tunnel.

23. The route optimization method of claim 20, wherein the PCH is a hop-by-hop option header.

24. The route optimization method of claim 20, wherein the PCH includes address information as option data and the address information is a CoA of the MR.

25. The route optimization method of claim 20, wherein the HAs recognize that their associated MRs overlap each other, based on a PCH-piggybacked packet from HAs located in their upper layer.

26. The route optimization method of claim 20, wherein a PCH having address information for each of all MRs for an upper tunnel is piggybacked on a packet destined for the CR before being transmitted.

27. The route optimization method of claim 20, further comprising the step of determining, by the HA, whether to perform piggybacking on the packet, based on a source and a destination of the packet.

28. The route optimization method of claim 27, wherein the step of determining whether to perform the piggybacking comprises the steps of:
if a packet of which a source is identical to a destination is continuously received from a tunnel between the MR and the HA, after the performing piggybacking, recognizing absence of a CR in a route to the CN; and
ending piggybacking on the PCH.

29. The route optimization method of claim 28, wherein if there is no CR, the CN searches for a CR adjacent thereto and forms a route-optimized tunnel using searched CR.

30. A route optimization system for packet transmission between particular modes in a mobile network including a plurality of nodes, the system comprising:
a home agent (HA); and
a mobile router (MR) for, if a packet is transmitted from a predetermined mobile node, transmitting the packet to the HA through a previously established default tunnel and optimizing a route to a correspondent router (CR) that transmits the packet, by analyzing a path control header (PCH) included in the packet destined therefore,
wherein the HA piggybacks a PCH representing address information of the MR on the packet, and transmits the PCH-piggybacked packet to its associated MR of a correspondent node (CN) for which the packet is destined.

31. The route optimization system of claim 30, wherein if a packet is transmitted from the MR, the HA searches its own table for address information corresponding to the MR and generates a new packet by adding the searched address information of the MR to the packet.

32. The route optimization system of claim 30, wherein the HA directly transmits the packet to the CN, upon recognizing an absence of an MR associated with the CN.

33. The route optimization system of claim 30, wherein the HA recognizes that its associated MR overlaps another MR, based on a PCH-piggybacked packet from an HA located in its upper layer.

34. The route optimization system of claim 30, wherein the HA determines whether to perform piggybacking on the packet based on a source and a destination of the packet.

35. The route optimization system of claim 34, wherein if a packet, for which a source is identical to a destination, is continuously received from a tunnel between the MR and the HA, after the piggybacking, the HA recognizes an absence of a CR in a route to the CN, and ends piggybacking on the PCH.

36. The route optimization system of claim 30, wherein address information of the MR is a care-of-address (CoA) of the MR.

37. The route optimization system of claim 30, wherein the CR includes an HA, an MR, an access router (AR), and a boarder router (BR), and performs route optimization by analyzing the PCH.

38. The route optimization system of claim 30, wherein the PCH is a hop-by-hop option header.

39. The route optimization system of claim 30, wherein the PCH has address information as option data.
